(19) United States
(12) Patent Application Publication
(10) Pub. No.: US 2011/0072476 A1
(43) Pub. Date: Mar. 24, 2011

(54) SYSTEM, METHOD, AND APPARATUS FOR BROADCAST CONTENT DISTRIBUTION

(75) Inventor: Serge RUTMAN, Boulder Creek, CA (US)

(73) Assignee: FIRSTPAPER LLC, NEW YORK, NY (US)

(21) Appl. No.: 12/563,328

(22) Filed: Sep. 21, 2009

(51) Int. Cl. H04N 7/173; H04B 7/24

(52) U.S. Cl. 725/105; 455/39

(57) ABSTRACT

A system and method for broadcasting periodical content to one or more reader devices in accordance with exemplary embodiments may include receiving, from a content system, processed periodical content, determining a distribution schedule that indicates one or more scheduled times at which the processed periodical content is scheduled to be distributed to the one or more reader devices, and broadcasting, via a broadcast communication network, the processed periodical content for distribution to the one or more reader devices using a broadcast channel over the air in accordance with the distribution schedule.

### FIELD OF THE INVENTION

The present invention relates to content distribution, generally, and a system, method, and apparatus for broadcasting periodical content, in particular.

### BACKGROUND INFORMATION

Generally, many mobile devices may maintain bidirectional communication with one or more communication towers (e.g., cellular towers) using several point-to-point communication channels. Such point-to-point communication channels, however, may utilize a substantial amount of the bandwidth available for a wireless service provider. In certain cases, bidirectional communication may not be necessary for successful communication between the one or more communication towers and the mobile devices.

### BRIEF DESCRIPTION OF THE DRAWINGS

Purposes and scope of exemplary embodiments described below will be apparent from the following detailed description in conjunction with the appended drawings in which like reference characters are used to indicate like elements, and in which:

FIG. 1 illustrates a block diagram of a broadcast content distribution network according to an embodiment of the invention;

FIG. 2 illustrates exemplary modules of a broadcast communication network portion of a broadcast content distribution network according to an embodiment of the invention;

FIG. 3 illustrates exemplary modules of a reader device of a content distribution network according to an embodiment of the invention;

FIG. 4 is a flow chart illustrating a method for broadcasting periodical content to one or more reader devices according to an embodiment of the invention; and

FIG. 5 is a flow chart illustrating another method for broadcasting periodical content to one or more reader devices according to an embodiment of the invention.

### SUMMARY OF EMBODIMENTS OF THE INVENTION

At least one exemplary embodiment may provide a method for broadcasting periodical content to one or more reader devices. This embodiment may include receiving, from a content system, processed periodical content, determining a distribution schedule that indicates one or more scheduled times at which the processed periodical content is scheduled to be distributed to the one or more reader devices, and broadcasting, via a broadcast communication network, the processed periodical content for distribution to the one or more reader devices using a broadcast channel over the air in accordance with the distribution schedule.

Another exemplary embodiment according to this invention may provide a system for broadcasting periodical content to one or more reader devices. This embodiment may include a distribution schedule computing apparatus configured to receive processed periodical content from a content system, the distribution schedule computing apparatus configured to determine a distribution schedule that indicates one or more scheduled times at which the processed periodical content is scheduled to be distributed to the one or more reader devices, and a distribution computing apparatus configured to broadcast the processed periodical content via a broadcast communication network for distribution to the one or more reader devices using a broadcast channel over the air in accordance with the distribution schedule.

Another exemplary embodiment according to this invention may provide a method for broadcasting periodical content to one or more reader devices. This embodiment may include receiving, from a distribution system, processed periodical content and at least one distribution schedule, encoding, using a programmed computer, the processed periodical content in accordance with one or more channel coding techniques for coding data to be broadcasted over a broadcast channel, and broadcasting, from a transmission tower, the processed and encoded periodical content over the air over the broadcast channel that is communicatively coupled to the one or more reader devices in accordance with the distribution schedule.

Another exemplary embodiment according to this invention may provide a system for broadcasting periodical content to one or more reader devices. This embodiment may include a periodical content coding computing apparatus configured to receive processed periodical content and at least one distribution schedule from a distribution system, the periodical content coding computing apparatus configured to encode the processed periodical content in accordance with one or more channel coding techniques for coding data to be broadcasted over a broadcast channel, and a periodical content transmission computing apparatus configured to broadcast the processed and encoded periodical content, from a transmission tower, over the air over the broadcast channel that is communicatively coupled to the one or more reader devices in accordance with the distribution schedule.

### DETAILED DESCRIPTION OF EMBODIMENTS OF THE INVENTION

Currently, paper based publications (e.g., hard copies of newspapers, hard copies of magazines) may be distributed to subscribers using traditional delivery mechanisms (e.g., home delivery via publication delivery vehicles, office delivery via publication delivery vehicles). Advancements in electronic distribution technologies may enable the distribution of electronic versions of publications (e.g., perishable publication content, web-based content) to be delivered to end-user devices via point-to-point communication. Such point-to-point communication may include point-to-point wireless data communication, point-to-point cellular data communication, or a combination of both. The distribution of electronic versions of publications via point-to-point communication, however, may be costly and inefficient.

Electronic versions of publications may be distributed to subscribers in a cost-effective and efficient manner using a broadcast content distribution network. A broadcast content distribution network may be communicatively coupled to one or more broadcast communication networks. A broadcast communication network may include any, or a combination, of one or more Frequency Modulate (FM) radio transmission towers, one or more Amplitude Modulate (AM) radio transmission towers, one or more television transmission towers, one or more satellite radio networks, and any other transmission device that may be used to broadcast periodical content. Accordingly, a broadcast communication network may be configured to broadcast periodical content over one or more broadcast channels initiated by any, or a combination, of the one or more FM radio transmission towers, the one or more Amplitude Modulate AM radio transmission towers, the one or more television transmission towers, and the one or more satellite radio networks.

For example, a broadcast content distribution network may communicate periodical content to be distributed to one or more reader devices to a broadcast communication network. Subsequently, the broadcast communication network may distribute the periodical content to the one or more reader devices via any, or a combination, of the one or more FM radio transmission towers, the one or more AM radio transmission towers, the one or more television transmission towers, and the one or more satellite radio networks. For example, the broadcast communication network may distribute first periodical content to the one or more reader devices via a broadcast channel from a television transmission tower (e.g., a television transmission tower associated with the WCVB-TV television station). In another example, the broadcast communication network may distribute second periodical content to the one or more reader devices via a broadcast channel from an FM radio transmission tower (e.g., an FM radio transmission tower associated with the WIYY-FM radio station). In yet another example, the broadcast communication network may distribute third periodical content to the one or more reader devices via a broadcast channel from an AM radio transmission tower (e.g., an AM radio transmission tower associated with the WBAL-AM radio station). In yet a further example, the broadcast communication network may distribute fourth periodical content to the one or more reader devices via a broadcast channel from a satellite radio network (e.g., a satellite radio network associated with a XM radio station).

As previously described, a broadcast content distribution network may operate using point-to-multipoint communication by broadcasting periodical content to one or more reader devices using a broadcast communication network. Periodical content may include electronic media information that is periodically distributed to an audience (e.g., an electronic news feed). For example, periodical content may include an electronic version of a daily newspaper (e.g., the electronic version of the Connecticut Post newspaper). In another example, periodical content may include an electronic version of a monthly magazine (e.g., the electronic version of the Cosmopolitan magazine). In yet another example, periodical content may include an electronic version of an up-to-date breaking news source (e.g., the electronic version of Hearst News Service's breaking news). It should be noted that the broadcast content distribution network may also be configured to broadcast non-perishable content to one or more reader devices, such as content associated with one or more books.

In an exemplary embodiment, a broadcast content distribution network may determine a distribution schedule prior to broadcasting the periodical content to the one or more reader devices. A distribution schedule may indicate one or more scheduled times at which the periodical content is to be distributed. In various embodiments, the broadcast content distribution network may determine the distribution schedule in accordance with one or more business rules that define one or more distribution requirements, such as: 1) distribute the periodical content associated with a daily periodical source once per night; 2) distribute the periodical content associated with a weekly periodical source once per week; 3) distribute the periodical content associated with a monthly periodical source once per month; 4) distribute the periodical content associated with a hourly periodical source once per hour; and 5) distribute the periodical content associated with a live periodical source in real time. In various embodiments, a periodical source may include any source that provides periodical content.

In an exemplary embodiment, a broadcast content distribution network may encode the periodical content prior to broadcast transmission to the one or more reader devices. In various embodiments, the broadcast content distribution network may employ one or more encoding algorithms to encode the periodical content such that end-users that have subscribed to the periodical content may access or view the periodical content using their reader devices. In various embodiments, the broadcast content distribution network may employ one or more compression encoding algorithms to reduce the volume (e.g., size) of the periodical content that is broadcasted.

In an exemplary embodiment, a broadcast content distribution network may broadcast the periodical content to the one or more reader devices using one or more broadcast channels supplied by a broadcast communication network. Accordingly, the broadcast content distribution network may support unidirectional communication of the periodical content from the broadcast communication network to the one or more reader devices.

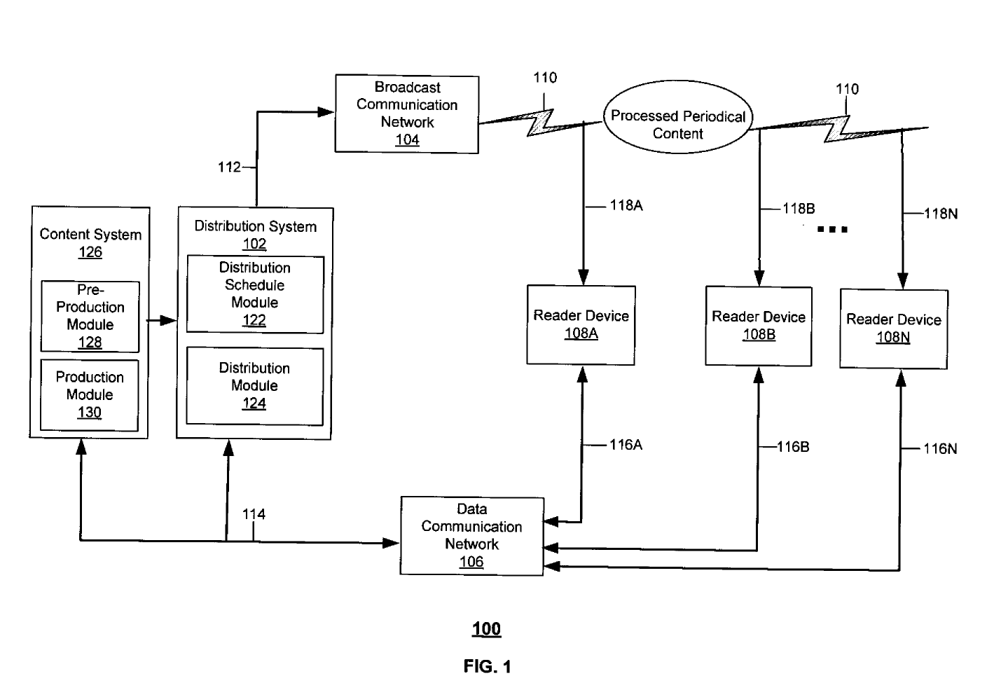

FIG. 1 illustrates a block diagram of a broadcast content distribution network (“BCDN”) 100 according to an embodiment of the invention. In one embodiment, the BCDN 100 may include a content system 126, a distribution system 102, a broadcast communication network 104, a data communication network 106, and one or more reader devices 108A, 108B, 108N. The distribution system 102 may distribute processed periodical content to the one or more reader devices 108A, 108B, 108N over a broadcast channel 110 provided by the broadcast communication network 104.

The content system 126 may be communicatively coupled to the distribution system 102 via data path 132. The content system 126 may include any, or a combination, of software and hardware configured to provide any, or a combination, of pre-production services and production services. Accordingly, the content system 126 may include a pre-production module 128 and a production module 130. The functionalities of the pre-production module 128 may include the functionalities of the pre-production system 110 described in U.S. patent application Ser. No. 12/248,482 entitled “Systems, Methods And Apparatus For Content Distribution,” filed on Oct. 9, 2008, which is incorporated by reference herein in its entirety. For example, the pre-production module 128 of the content system 126 may be configured to perform the functions or operations of pre-production system 110 of U.S. patent application Ser. No. 12/248,482. The functionalities of the production module 130 may include the functionalities of the production system 120 described in U.S. patent application Ser. No. 12/248,482. For example, the production module 130 of the content system 126 may be configured to perform the functions or operations of production system 120 of U.S. patent application Ser. No. 12/248,482.

The content system 126 may be configured to output processed periodical content to the distribution system 102 via data path 132. Processed periodical content may include periodical content that has been modified in accordance with the functionalities or operations of the pre-production module 128 and the production module 130. Accordingly, processed periodical content may include a final version of the periodical content that is ready for any, or a combination, of publishing and distribution.

The distribution system 102 may include any, or a combination, of software and hardware configured to receive processed periodical content from the content system 126 via data path 132. From the distribution system 102, processed periodical content may be transmitted to one or more available broadcast communication networks 104 for broadcast transmission to one or more reader devices 108A, 108B, 108N.

The distribution system 102 may include publishing logic configured to publish the processed periodical content. The distribution system 102 may also include a distribution module 124 (e.g., distribution logic) configured to transmit the processed periodical content to the broadcast communication network 104 for broadcast transmission over the broadcast channel 110 to one or more of the reader devices 108A, 108B, 108N.

The distribution system 102 may include a distribution schedule module 122 configured to perform methods for any, or a combination, of optimizing network bandwidth consumption for point-to-multipoint distribution and providing guaranteed on-time processed periodical content delivery services (e.g., timely distribution). By way of example, but not limitation, timely distribution of processed periodical content to end-users may include distribution every morning, every evening, at 7:00 AM, 7:00 PM, or any other selected time interval or time.

The distribution schedule module 122 may be configured to generate or determine a distribution schedule that indicates one or more scheduled times at which the processed periodical content is to be distributed. In one embodiment, the distribution schedule module 122 may be configured to generate or determine a distribution schedule in accordance with one or more business rules that define one or more distribution requirements, such as: 1) distribute the processed periodical content associated with a daily periodical source once per night or once per day; 2) distribute the processed periodical content associated with a weekly periodical source once per week; 3) distribute the processed periodical content associated with a monthly periodical source once per month; 4) distribute the processed periodical content associated with a hourly periodical source once per hour; and 5) distribute the processed periodical content associated with a live periodical source in real time.

For example, a first distribution schedule may schedule first processed periodical content (e.g., a daily newspaper such as the Connecticut Post) to be distributed every morning at 2:00 AM (e.g., at a time prior to the availability or delivery of the hard copy version of the Connecticut Post news paper, at a time that is the same as the availability or delivery of the hard copy version of the Connecticut Post news paper). In another example, a second distribution schedule may schedule second processed periodical content (e.g., a monthly magazine such as the Cosmopolitan) to be distributed on the first (1^{st}) of every month at 2:00 AM (e.g., at a time prior to the availability or delivery of the hard copy version of the Cosmopolitan magazine, at a time that is the same as the availability or delivery of the hard copy version of the Cosmopolitan magazine). In yet another example, a third distribution schedule may schedule third processed periodical content (e.g., an up-to-date breaking news source such as Hearst News Service's breaking news) to be distributed immediately (e.g., as soon as practicable to ensure delivery of processed periodical content that is not stale).

There may be a plurality of managed factors and constraints in the BCDN 100 regarding on-time content delivery services to assure that distribution to a reader devices 108A, 108B, 108N is performed on-time. In some embodiments, performing distribution on-time may include performing distribution up to ten minutes after the targeted distribution time. The factors may include, but are not limited to periodical content availability time or periodical content processing time. A complex engine may consider one or more of these variables in the workflow engine to improve the likelihood of on-time delivery. This may be similar to print newspaper distribution processes, and timing constraints, but may be applied to an electronic edition (e.g., the processed periodical content).

In one embodiment, the business rules for the distribution schedule may include one or more of the following: the processed periodical content distribution strategy may be optimized for off-peak broadcast times (e.g. 9:00 PM to 6:00 AM), the geographical time zone (e.g., Pacific Standard Time, Eastern Standard Time, Greenwich Mean Time) of the reader device may be considered, the reader devices powering up time and tuning to the broadcast channel without input from an end-user may be considered, reader device tuning time may be optimized so as to limit power consumption and battery life (e.g., limiting broadcast channel tuning time to every ten minutes if powered on, limiting broadcast channel tuning to a response to a received broadcast message trigger), processed periodical content may be compressed on a server and optimized for content delivery or file size, a connection manager associated with the reader device may obtain a broadcast time or the distribution schedule from the distribution schedule module 122, and processed periodical content may be broadcasted on different broadcast channels based on one or more business rules.

The distribution schedule module 122 may include any, or a combination, of software and hardware configured to acquire or receive processed periodical content for publication and schedule the distribution of the processed periodical content. In one embodiment, the distribution schedule module 122 may schedule the processed periodical content to be distributed to the reader devices 108A, 108B, 108N at approximately the same time as hard copy, paper editions of the periodical content (e.g., within five minutes before or after the delivery of the hard copy, paper editions of the periodical content). To ensure timely distribution of the processed periodical content, the propagation time for the processed periodical content to be received at the reader devices 108A, 108B, 108N may be estimated. The estimation may be used to provide distribution that meets a selected level of quality of service.

In various embodiments, the estimation may incorporate one or more of the following factors: the size of the processed periodical content, the population of local end-users (e.g., subscribers) in a target market, the performance of a broadcast communication network, and the applicable time zone of the target market. Propagation time may be a variable based on file size, type of broadcast communication network, quality of reception, or other parameters. Taking in consideration the uncertain nature of broadcast communication networks, the propagation time may be better defined as a time window (e.g., five minutes, fifteen minutes, thirty minutes, one hour) for successfully delivering the processed periodical content to the reader devices 108A, 108B, 108N.

In some embodiments, the propagation time estimation may be based on an algorithm combining one or more factors towards obtaining efficient and effective on-time delivery. The factors may include, but are not limited to, the time required for delivery, the time zone that the reader device is in, and the broadcast channels available when the processed periodical content is transmitted to the reader devices 108A, 108B, 108N.

The distribution system 102 may be configured to initiate the distribution of the processed periodical content based on the outcome of the functions of the distribution system 102. Accordingly, the distribution system 102 may be configured to transmit the processed periodical content to the broadcast communication network 104 via data path 112.

The broadcast communication network 104 may include any, or a combination, of software and hardware configured to receive the processed periodical content from the distribution system 102. In various embodiments, the broadcast communication network 104 may include any, or a combination, of software and hardware configured to broadcast the processed periodical content to the reader devices 108A, 108B, 108N via broadcast channel 110 in accordance with the distribution schedule. For example, the broadcast communication network 104 may include any, or a combination, of one or more FM radio transmission towers, one or more AM radio transmission towers, one or more television transmission towers, and one or more satellite radio networks configured to broadcast the processed periodical content to the reader devices 108A, 108B, 108N via broadcast channel 110 in accordance with the distribution schedule. Although FIG. 1 illustrates the use of a single broadcast channel (e.g., broadcast channel 110), it should be noted that broadcast communication network 104 may utilize one or more broadcast channels that are capable of broadcasting the processed periodical content to the reader devices 108A, 108B, 108N. In addition, it should be noted that broadcast channel 110 may include any, or a combination, of a wireless communication link, a wired communication link, and a network. The broadcast communication network 104 is described in further detail below.

The reader devices 108A, 108B, 108N may include any, or a combination, of software and hardware configured to tune to one or more broadcast channels, such as broadcast channel 110. In various embodiments, the reader devices 108A, 108B, 108N may be configured to receive the processed periodical content from the broadcast channel 110 at one or more scheduled times (e.g., approximate scheduled times) indicated by the distribution schedule via unidirectional data paths 118A, 118B, 118N, respectively. In various embodiments, the reader devices 108A, 108B, 108N may be configured to display the processed periodical content to the end-user (e.g., subscriber) using a display device (e.g., a display screen, a plasma screen, a Liquid Crystal Display (LCD) device). The functionalities of the reader devices 108A, 108B, 108N may include those described in U.S. patent application Ser. No. 12/248,331 entitled “Media Display Device And Method Of Operation Thereof,” filed on Oct. 9, 2008, which is incorporated by reference herein in its entirety.

In one embodiment, the reader devices 108A, 108B, 108N may be communicatively coupled to one or more data communication networks, such as data communication network 106. For example, reader device 108A may be configured for bidirectional communication with data communication network 106 via bidirectional data path 116A. In another example, reader device 108B may be configured for bidirectional communication with data communication network 106 via bidirectional data path 116B. In yet another example, reader device 108N may be configured for bidirectional communication with data communication network 106 via bidirectional data path 116N.

The reader devices 108A, 108B, 108N may allow the end-users (e.g., subscribers) to communicate with, any, or a combination, of content system 126 and distribution system 102 via data communication network 106 and data path 114. For example, end-users may register with the BCDN 100, subscribe to receive processed periodical content from one or more periodical sources, or perform other tasks that use bidirectional communication using the reader devices 108A, 108B, 108N. The reader devices 108A, 108B, 108N are described in further detail below.

The BCDN 100 may be in communication with data communication network 106. Data communication network 106 may include an analog telephone network, a digital telephone network, a cellular telephone network, a public wide area network (“WAN”), such as the Internet, or different connections, such as: combinations of public and private WANs, local areas networks (“LANs”), wireless LANs, encrypted networks, body area networks, or other wired or wireless networks. In one embodiment, data communication network 106 may include one, or any number of the exemplary types of networks mentioned above operating as a stand-alone network or in cooperation with each other. Use of the term data communication network herein is not intended to limit the data communication network 106 to a single network.

The BCDN 100 may be configured to determine whether to communicate periodical content to the reader devices 108A, 108B, 108N via the broadcast communication network 104 (using unidirectional communication) or the data communication network 106 (using bidirectional communication) based on one or more factors. These one or more factors may include the location of the reader devices 108A, 108B, 108N, the broadcast history of the reader devices 108A, 108B, 108N, and any other factor that may be used to determine whether unidirectional communication or bidirectional communication is most efficient. In one embodiment, a location of a reader device may include an approximate location of the reader device that is used to determine whether the reader device is out of range to receive periodical content via a broadcast transmission. Accordingly, the BCDN 100 may determine to communicate periodical content to the reader devices 108A, 108B, 108N via the data communication network 106 using bidirectional communication. In another embodiment, a broadcast history of a reader device may indicate that amount of times broadcast transmissions were successfully received by the reader device. Accordingly, the BCDN 100 may determine to communicate periodical content to reader devices that have a poor broadcast history via the data communication network 106 using bidirectional communication. The successfulness of a broadcast history may be determined using one or more thresholds. In the event of a broadcast transmission failure, the BCDN 100 may be configured to retransmit periodical content using the broadcast communication network 104 (using unidirectional communication) or the data communication network 106 (using bidirectional communication).

One or more data paths disclosed herein may include any device that communicatively couples one or more devices to each other. For example, one or more data paths may include one or more networks or one or more conductive wires (e.g., copper wires).

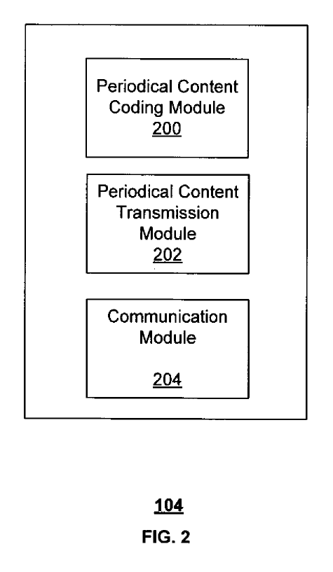

FIG. 2 illustrates exemplary modules of a broadcast communication network 104 portion of a BCDN 100 according to an embodiment of the invention. In an exemplary embodiment, the broadcast communication network 104 may include a periodical content coding module 200, a periodical content transmission module 202, and a communication module 204. It is noted that the modules 200, 202, and 204 are exemplary. The functions of the modules 200, 202, and 204 may be performed at other modules remote or local to the broadcast communication network 104, and the modules 200, 202, and 204 may be combined or separated.

The communication module 204 may include any, or a combination, of software and hardware configured to receive the processed periodical content and the distribution schedule from the distribution system 102 via data path 112. In one embodiment, the communication module 204 may be configured to communicate the processed periodical content and the distribution schedule received to one or more other modules of the broadcast communication network 104, such as: the periodical content coding module 200 and the periodical content transmission module 202. In one embodiment, the communication module 204 may be configured to communicate one or more messages received from the other modules to one or more other modules.

The periodical content coding module 200 may include any, or a combination, of software and hardware to encode the processed periodical content prior to broadcast transmission. For example, the periodical content coding module 200 may include one or more encoder devices well known to those of ordinary skill in the art, such as an encoder configured to comply with the Advanced Television Systems Committee (ATSC) standard's Mobile Pedestrian Handheld (MPH™) standard.

The periodical content coding module 200 may be configured to employ one or more encoding algorithms to encode the processed periodical content such that end-users (e.g., subscribers) that have subscribed to the periodical content are allowed to access or view the periodical content using their reader devices. Such encoding may include applying one or more well-known encryption techniques that are used to protect proprietary information, such as the processed periodical content. Such well-known encryption techniques may include the Data Encryption Standard (DES) encryption technique and the Advanced Encryption Standard (AES) encryption technique.

The periodical content coding module 200 may be configured to employ one or more compression encoding algorithms to encode the processed periodical content such that the volume size of the processed periodical content to be broadcasted is reduced. Accordingly, the one or more compression encoding algorithms may be used to reduce the volume of the broadcasted content.

In one embodiment, the periodical content coding module 200 may employ one or more loss-less compression encoding algorithms to encode the processed periodical content or any other data transmitted to the reader devices. The loss-less compression encoding algorithms may be used to encode data (e.g., one or more code portions) that is intended to update at least a portion of an executable component (e.g., the operating system of a reader device, an application of a reader device) of the reader devices. Such loss-less compression encoding algorithms may include Run Length Coding or PKZIP coding.

In one embodiment, the periodical content coding module 200 may employ one or more “lossy” compression encoding algorithms to encode the processed periodical content or any other data transmitted to the reader devices. The lossy compression encoding algorithms may be used to encode the processed periodical content, such as images, audio clips, and video clips associated with the processed periodical content. Such lossy compression encoding algorithms may include the Joint Photographic Experts Group (JPEG) encryption technique, the Moving Picture Experts Group-2 (MPEG-2) encryption technique, and the MPEG-4 encryption technique.

The periodical content coding module 200 may be configured to employ any, or a combination, of one or more channel encoding devices and one or more channel encoding algorithms to channel encode the processed periodical content. In one embodiment, the periodical content coding module 200 may use one or more channel encoder devices or channel encoder algorithms that are well known in the art to comply with one or more broadcasting system standards. For example, the periodical content coding module 200 may use one or more channel encoder devices or one or more channel encoder algorithms that are configured to comply with the MPH™ standard. In another example, the periodical content coding module 200 may use one or more channel encoder devices or one or more channel encoder algorithms that are configured to comply with one or more standards supported by the iBiquity Digital Corporation. It should be noted that any well-known in-band, out-of-band, or side-band devices or algorithms may be used by the periodical content coding module 200 and the reader devices to enable successful broadcast transmission.

After the periodical content coding module 200 encodes the processed periodical content in accordance with one or more encoding algorithms, the periodical content transmission module 202 may distribute the processed and encoded periodical content via broadcast transmission. The periodical content transmission module 202 may include any, or a combination, of software and hardware configured to broadcast the processed and encoded periodical content via broadcast channel 110. In one embodiment, the periodical content transmission module 202 may include one or more devices well known in the art for broadcasting content. For example, the periodical content transmission module 202 may include one or more transmitters, one or more exciters, one or more modulators configured to comply with the MPH™ standard.

In one embodiment, the periodical content transmission module 202 may be configured to broadcast the processed and encoded periodical content in accordance with the distribution schedule. For example, the periodical content transmission module 202 may be configured to broadcast first processed periodical content (e.g., a daily newspaper such as the Connecticut Post) every morning at 2:00 AM (e.g., at a time prior to the availability or delivery of the hard copy version of the Connecticut Post news paper, at a time that is the same as the availability or delivery of the hard copy version of the Connecticut Post news paper) in accordance with a first distribution schedule. In another example, the periodical content transmission module 202 may be configured to broadcast second processed periodical content (e.g., a monthly magazine such as the Cosmopolitan) on the first (1^{st}) of every month at 2:00 AM (e.g., at a time prior to the availability or delivery of the hard copy version of the Cosmopolitan magazine, at a time that is the same as the availability or delivery of the hard copy version of the Cosmopolitan magazine) in accordance with a second distribution schedule. In yet another example, the periodical content transmission module 202 may be configured to broadcast third processed periodical content (e.g., an up-to-date breaking news source such as Hearst News Service's breaking news) immediately (e.g., as soon as practicable to ensure delivery of processed periodical content that is not stale) in accordance with a third distribution.

The periodical content transmission module 202 may be configured to generate or broadcast one or more broadcast message triggers. In one embodiment, a broadcast message trigger may include a data message that indicates the imminence of a broadcast transmission of the processed periodical content. Accordingly, the periodical content transmission module 202 may broadcast one or more broadcast message triggers at a time prior to the broadcast transmission of the processed and encoded periodical content.

The periodical content transmission module 202 may be configured to divide the processed and encoded periodical content into one or more smaller blocks of data (e.g., one kilobyte data blocks) prior to transmission. In one embodiment, the processed and encoded periodical content may be divided in one or more smaller blocks of data according to one or more division points (e.g., a point of the processed and encoded periodical content that indicates a page break, a point of the processed and encoded periodical content that indicates a section break) associated with the processed and encoded periodical content. Accordingly, in the event of a network failure or a transmission error, the periodical content transmission module 202 may transmit or retransmit one or more smaller blocks of data to the reader devices via broadcast transmission.

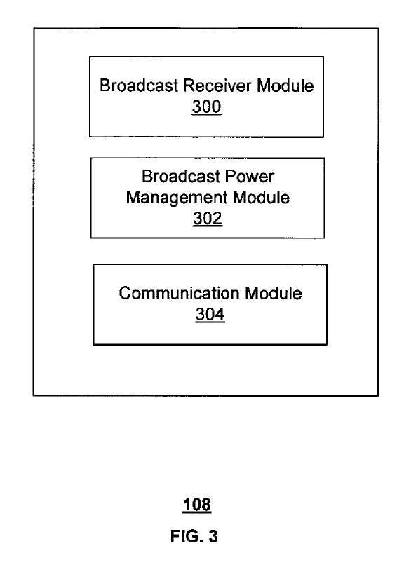

FIG. 3 illustrates exemplary modules of a reader device 108 of a BCDN 100 according to an embodiment of the invention. In an exemplary embodiment, the reader device 108 may include a broadcast receiver module 300, a broadcast power management module 302, and a communication module 304. It is noted that the modules 300, 302, and 304 are exemplary. The functions of the modules 300, 302, and 304 may be performed at other modules remote or local to the reader device 108, and the modules 300, 302, and 304 may be combined or separated. The functionalities of the reader devices 108A, 108B, 108N may include those described in U.S. patent application Ser. No. 12/248,331 entitled “Media Display Device And Method Of Operation Thereof,” filed on Oct. 9, 2008, which is incorporated by reference herein in its entirety.

The broadcast power management module 302 may include any, or a combination, of software and hardware configured to maintain power while the remaining portions of the reader device 108 are powered down. In one embodiment, the broadcast power management module 302 may listen to one or more broadcast channels to detect when one or more broadcast message triggers have been broadcasted and received. For example, the broadcast power management module 302 may maintain the reader device 108 in a low-power mode of operation such that the reader device 302 operates on a minimal amount of power until the one or more broadcast message triggers are received (e.g., indicating a need to tune to and listen to a broadcast channel). Once one or more broadcast message triggers are detected, the broadcast power management module 302 may power up or initiate the power up of the remaining portions of the reader device 108 in anticipation of the broadcast transmission of the processed and encoded periodical content. In various embodiments, the broadcast power management module 302 may power up the entire reader device 108 in anticipation of the broadcast transmission or power up the portion of the reader device 108 necessary to receive and store the processed and encoded periodical content.

The broadcast power management module 302 may include any, or a combination, of software and hardware configured to listen to one or more broadcast channels at one or more scheduled times indicated in the distribution schedule. Accordingly, during times of low activity, one or more portions of the reader device 108 (e.g., one or more processing units, one or more display units, one or more listening units, one or more data units, one or more control units) may power down.

The broadcast receiver module 300 may include any, or a combination, of software and hardware configured to tune to one or more broadcast channels that are configured to broadcast the processed and encoded periodical content. For example, the broadcast receiver module 300 may include one or more receiver devices well known to those of ordinary skill in the art, such as a receiver device configured to comply with the MPH™ standard. Accordingly, the broadcast receiver module 300 may receive the processed and encoded periodical content from broadcast channel 110 via unidirectional data path 118.

The broadcast receiver module 300 may include any, or a combination, of software and hardware configured to decode the processed and encoded periodical content such that the end-user (e.g., subscriber) may view the periodical content using a display device on the reader device 108.

The communication module 304 may include software any, or a combination, of and hardware configured to communicate with the data communication network 106. Accordingly, the communication module 304 may be configured to received data from and transmit data to the data communication network 106 via bidirectional data path 116. In one embodiment, the communication module 304 may be configured to communicate the data received to one or more other modules of the reader device 108, such as: the broadcast receiver module 300 and the broadcast power management module 302. In one embodiment, the communication module 304 may be configured to communicate one or more messages received from the other modules to one or more other modules.

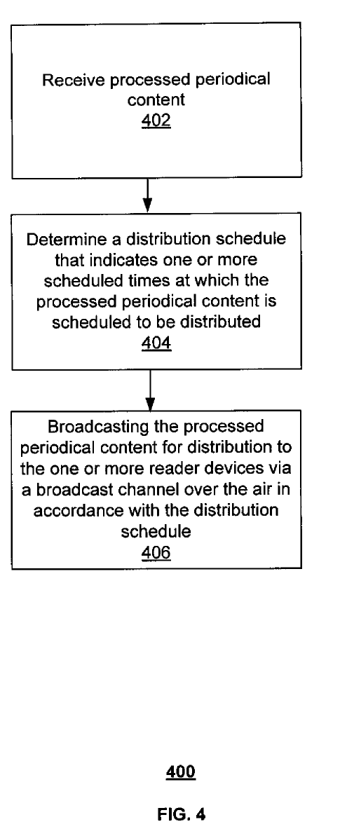

FIG. 4 is a flow chart illustrating a method for broadcasting periodical content to one or more reader devices according to an embodiment of the invention. This exemplary method is provided by way of example, as there are a variety of ways to carry out methods disclosed herein. The method 400 shown in FIG. 4 can be executed or otherwise performed by one or a combination of various systems. The method 400 is described below as carried out by the distribution system 102 shown in FIG. 1 by way of example, and various elements of the distribution system 102 are referenced in explaining the example method of FIG. 4. Each block shown in FIG. 4 represents one or more processes, methods, or subroutines carried in the exemplary method 400. Referring to FIG. 4, the exemplary method 400 may begin at block 402.

In block 402, the method 400 may include receiving processed periodical content. In one embodiment, the distribution system 102 may receive processed periodical content from the content system 126 via data path 132. For example, periodical content may include electronic media information that is periodically distributed to an audience (e.g., an electronic news feed). The method 400 may continue to block 404.

In block 404, the method 400 may include determining a distribution schedule that indicates one or more scheduled times at which the processed periodical content is scheduled to be distributed. In one embodiment, the distribution schedule module 122 of the distribution system 102 may determine the distribution schedule according to one or more business rules that define one or more distribution requirements. The method 400 may continue to block 406.

In block 406, the method 400 may include broadcasting the processed periodical content for distribution to the one or more reader devices via a broadcast channel over the air in accordance with the distribution schedule. In one embodiment, the distribution module 124 of the distribution system 102 may transmit the processed periodical content to the broadcast communication network 104 for broadcast transmission over the broadcast channel 110. The method 400 may then end.

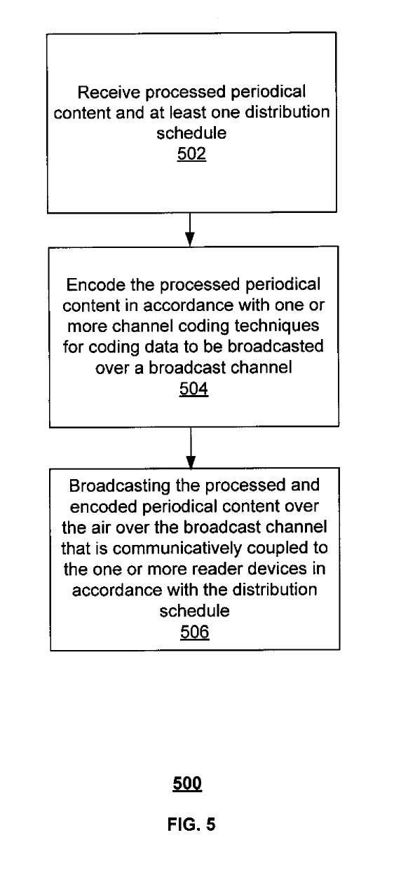

FIG. 5 is a flow chart illustrating another method for broadcasting periodical content to one or more reader devices according to an embodiment of the invention. This exemplary method is provided by way of example, as there are a variety of ways to carry out methods disclosed herein. The method 500 shown in FIG. 5 can be executed or otherwise performed by one or a combination of various systems. The method 500 is described below as carried out by the broadcast communication network 104 shown in FIG. 1 by way of example, and various elements of the broadcast communication network 104 are referenced in explaining the example method of FIG. 5. Each block shown in FIG. 5 represents one or more processes, methods, or subroutines carried in the exemplary method 500. Referring to FIG. 5, the exemplary method 500 may begin at block 502.

In block 502, the method 500 may include receiving processed periodical content and at least one distribution schedule. In one embodiment, the communication module 204 may receive processed periodical content and at least one distribution schedule from the distribution system 102 via data path 112. The method 500 may continue to block 504.

In block 504, the method 500 may include encoding the processed periodical content in accordance with one or more channel coding techniques for coding data to be broadcasted over a broadcast channel. In one embodiment, the periodical content coding module 200 of the broadcast communication network 104 may encode the processed periodical content in accordance with one or more channel coding techniques for coding data to be broadcasted over a broadcast channel. The method 500 may continue to block 506.

In block 506, the method 500 may include broadcasting the processed and encoded periodical content over the air over the broadcast channel that is communicatively coupled to the one or more reader devices in accordance with the distribution schedule. In one embodiment, the periodical content transmission module 202 of the broadcast communication network 104 may broadcast the processed and encoded periodical content over the air over the broadcast channel that is communicatively coupled to the one or more reader devices in accordance with the distribution schedule from a transmission device (e.g., a radio transmission tower, a television transmission tower, a satellite radio network). The method 500 may then end.

It should be noted that one or more of the systems described above may be configured to operate in accordance with one or more device requirements provided by the SiPort Corporation of Santa Clara, Calif. or the iBiquity Digital Corporation of Columbia, Md. In addition, it should be noted that one or more of the systems described above may be configured to operate in accordance with one or more European television standards, such as one or more Digital Video Broadcast (DVB) standards.

The description above describes systems, networks, and reader devices, that may include one or more modules, some of which are explicitly shown in the figures. As used herein, the term “module” may be understood to refer to any, or a combination, of computing software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein may be tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks, and reader devices) separately. The functions described as being performed at various components may be performed at other components, and the various components may be combined or separated. Other modifications also may be made.

In the instant specification, various exemplary embodiments have been described with reference to the accompanying drawings. It will, however, be evident that various modifications or changes may be made thereto, or additional embodiments may be implemented, without departing from the broader scope of the invention as set forth in the claims that follow. The specification and drawings are accordingly to be regarded in an illustrative rather than a restrictive sense.

1. A computer-implemented method for broadcasting periodical content to one or more reader devices, the computer-implemented method comprising:
receiving, from a content system, processed periodical content;
determining a distribution schedule that indicates one or more scheduled times at which the processed periodical content is scheduled to be distributed to the one or more reader devices; and
broadcasting, via a broadcast communication network, the processed periodical content for distribution to the one or more reader devices using a broadcast channel over the air in accordance with the distribution schedule.

2. The computer-implemented method of claim 1, wherein the broadcast communication network comprises one or more Frequency Modulation (FM) radio transmission towers.

3. The computer-implemented method of claim 1, wherein the broadcast communication network comprises one or more Amplitude Modulation (AM) radio transmission towers.

4. The computer-implemented method of claim 1, wherein the broadcast communication network comprises one or more television transmission towers.

5. The computer-implemented method of claim 1, wherein the one or more scheduled times indicated in the distribution schedule are determined in accordance with one or more business rules defining one or more distribution requirements.

6. The computer-implemented method of claim 5, wherein the one or more business rules are selected from a group consisting of: 1) distribute the processed periodical content associated with a daily periodical source once per night; 2) distribute the processed periodical content associated with a weekly periodical source once per week; 3) distribute the processed periodical content associated with a monthly periodical source once per month; 4) distribute the processed periodical content associated with a hourly periodical source once per hour; and 5) distribute the processed periodical content associated with a live periodical source in real time.

7. The computer-implemented method of claim 1, wherein the broadcast communication network is configured to broadcast the processed periodical content in accordance with one or more Advanced Television Systems Committee (ATSC) standards.

8. The computer-implemented method of claim 7, wherein the one or more Advanced Television Systems Committee (ATSC) standards comprise one or more Mobile Pedestrian Handheld (MPH) standards.

9. A computer-implemented system for broadcasting periodical content to one or more reader devices, the computer-implemented system comprising:
a distribution schedule computing apparatus configured to receive processed periodical content from a content system;
the distribution schedule computing apparatus configured to determine a distribution schedule that indicates one or more scheduled times at which the processed periodical content is scheduled to be distributed to the one or more reader devices; and
a distribution computing apparatus configured to broadcast the processed periodical content via a broadcast communication network for distribution to the one or more reader devices using a broadcast channel over the air in accordance with the distribution schedule.

10. The computer-implemented system of claim 9, wherein the broadcast communication network comprises one or more Frequency Modulation (FM) radio transmission towers.

11. The computer-implemented system of claim 9, wherein the broadcast communication network comprises one or more Amplitude Modulation (AM) radio transmission towers.

12. The computer-implemented system of claim 9, wherein the broadcast communication network comprises one or more television transmission towers.

13. The computer-implemented system of claim 9, wherein the one or more scheduled times indicated in the distribution schedule are determined in accordance with one or more business rules defining one or more distribution requirements.

14. The computer-implemented system of claim 13, wherein the one or more business rules are selected from a group consisting of: 1) distribute the processed periodical content associated with a daily periodical source once per night; 2) distribute the processed periodical content associated with a weekly periodical source once per week; 3) distribute the processed periodical content associated with a monthly periodical source once per month; 4) distribute the processed periodical content associated with a hourly periodical source once per hour; and 5) distribute the processed periodical content associated with a live periodical source in real time.

15. The computer-implemented system of claim 9, wherein the broadcast communication network is configured to broadcast the processed periodical content in accordance with one or more Advanced Television Systems Committee (ATSC) standards.

16. The computer-implemented system of claim 15, wherein the one or more Advanced Television Systems Committee (ATSC) standards comprise one or more Mobile Pedestrian Handheld (MPH) standards.

17. The computer-implemented system of claim 9, wherein the one or more reader devices are configured to employ one or more power management techniques.

18. The computer-implemented system of claim 17, wherein at least one of the one or more employed power management techniques comprise maintaining a portion of the one or more reader devices in power up mode to detect when a broadcast message trigger is received while a remaining portion of the one or more reader devices is in power down mode.

19. The computer-implemented system of claim 18, wherein the broadcast message trigger indicates an imminent broadcast transmission of the processed periodical content.

20. The computer-implemented system of claim 9, wherein the one or more reader devices are communicatively coupled to a data communication network.

21. The computer-implemented system of claim 20, wherein the data communication network comprises a bidirectional network configured to support bidirectional communication.

22. A computer-implemented method for broadcasting periodical content to one or more reader devices, the computer-implemented method comprising:
receiving, from a distribution system, processed periodical content and at least one distribution schedule;
encoding, using a programmed computer, the processed periodical content in accordance with one or more channel coding techniques for coding data to be broadcasted over a broadcast channel; and
broadcasting, from a transmission tower, the processed and encoded periodical content over the air over the broadcast channel that is communicatively coupled to the one or more reader devices in accordance with the distribution schedule.

23. The computer-implemented method of claim 22, wherein the transmission tower comprises a Frequency Modulation (FM) radio transmission tower.

24. The computer-implemented method of claim 22, wherein the transmission tower comprises an Amplitude Modulation (AM) radio transmission tower.

25. The computer-implemented method of claim 22, wherein the transmission tower comprises a television transmission tower.

26. A computer-implemented system for broadcasting periodical content to one or more reader devices, the computer-implemented system comprising:
a periodical content coding computing apparatus configured to receive processed periodical content and at least one distribution schedule from a distribution system;
the periodical content coding computing apparatus configured to encode the processed periodical content in accordance with one or more channel coding techniques for coding data to be broadcasted over a broadcast channel; and
a periodical content transmission computing apparatus configured to broadcast the processed and encoded periodical content, from a transmission tower, over the air over the broadcast channel that is communicatively coupled to the one or more reader devices in accordance with the distribution schedule.

27. The computer-implemented system of claim 26, wherein the transmission tower comprises a Frequency Modulation (FM) radio transmission tower.

28. The computer-implemented system of claim 26, wherein the transmission tower comprises an Amplitude Modulation (AM) radio transmission tower.

29. The computer-implemented method of claim 26, wherein the transmission tower comprises a television transmission tower.
